(19) United States
(12) Patent Application Publication
(10) Pub. No.: US 2020/0242615 A1
(43) Pub. Date: Jul. 30, 2020

(54) FIRST PARTY FRAUD DETECTION

(71) Applicant: FAIR ISAAC CORPORATION, Roseville, MN (US)

(72) Inventors: Radha Chandra, Berkeley, CA (US); Sharon Hatcher Tilley, Larkspur, CA (US); Michael McFadden, San Diego, CA (US); Supriti Singh, San Diego, CA (US); Michael Betron, Austin, CA (US); Mohammad Nikpour, Austin, TX (US); Elizabeth Lasher, Miami, FL (US); Yan Wei, Alameda, CA (US); Brendan Alexander Lacounte, Rio Rancho, MN (US); Adam Barker, San Rafael, CA (US); Jenny Rees, Provo, UT (US); Ian Whiteside, Novato, CA (US); Neil Stickels, Round Rock, TX (US)

(73) Assignee: FAIR ISAAC CORPORATION

(21) Appl. No.: 16/746,775

(22) Filed: Jan. 17, 2020

Related U.S. Application Data
(60) Provisional application No. 62/797,875, filed on Jan. 28, 2019.

(51) Int. Cl. G06Q 20/40; G06Q 40/02; G06F 16/901

(52) U.S. Cl. CPC G06Q 20/4016; G06F 16/9024; G06Q 40/025

(57) ABSTRACT

A computer-implemented fraud detection method and system for periodically identifying network associations in a consumer population at a national credit reporting agency and computing associated network level variables related to credit use and potential first party fraud for the consumer population. In response to receiving a request for a target account from among the consumer population the computer-implemented system retrieves credit report for the target account and computes tradeline or account level variables related to credit use and potential fraudulent behavior. A fraud score is calculated based on a combined evaluation of the network level variables and the tradeline or account level variables.

### CROSS-REFERENCE TO RELATED APPLICATION

This Application claims priority to and the benefit of the earlier filing date of provisional application Ser. No. 62/797,875, filed on Jan. 28, 2019 the content of which is hereby incorporated by reference herein in entirety.

### COPYRIGHT & TRADEMARK NOTICES

A portion of the disclosure of this patent document may contain material which is subject to copyright protection. The owner has no objection to facsimile reproduction by any one of the patent documents or the patent disclosure, as it appears in the Patent and Trademark Office patent file or records, but reserves all copyrights whatsoever.

Certain marks referenced herein may be common law or registered trademarks of the applicant, the assignee or third parties affiliated or unaffiliated with the applicant or the assignee. Use of these marks is for providing an enabling disclosure by way of example and shall not be construed to exclusively limit the scope of the disclosed subject matter to material associated with such marks.

### TECHNICAL FIELD

The disclosed subject matter generally relates to computer-implemented fraud detection technology and, more particularly, to automated systems or method for identifying and detecting possible first party fraud.

### Background

Detecting anomalies in events, such as in financial transactions, may be an early indication of fraud. Fraudulent transactions may originate in a variety of ways. The most prevalent type of fraud is referred to as identity theft and is typically initiated by a third party fraudster, who victimizes an honest first party by creating an unauthorized profile based on the first party's information. The third party then uses the stolen first party profile to fraudulently apply for credit and steal borrowed money obtained in the name of the first party victim.

In another scenario, an unscrupulous first party may intend to defraud a bank or other lender by creating a synthetic profile that may be based on a combination of the first party's true identity data as well as fabricated identity or credit information. The first party may thus build a fake profile that is not necessarily based on the stolen identity of a third party victim. Using the fake profile, the first party may apply for and obtain credit and later take advantage of an unsuspecting lender to borrow money which the first party does not intend to repay.

Traditionally, a bank can identify third party fraud when a victim contacts the bank to inform the bank that the victim did not apply for the card or loan in question, or if the bank receives an application which is flagged as a fraud alert by the credit bureau, often at the request of the victim or other entity. Without such safeguards, it is very difficult for the bank to determine with accuracy whether an application is the result of third party fraud. With respect to first party fraud, fraud detection is even more difficult, because the noted safeguards are usually not available.

For the above reasons, in a first party fraud scenario, a bank may not be capable of determining, with any accuracy or efficiency, whether an application is based on fabricated information, nor can the bank find out about entity associations that may be involved in credit abuse or fraud. Advanced and improved computing systems and computer-implemented fraud-detection technologies are needed that can overcome the noted shortcomings and inefficiencies.

### SUMMARY

For purposes of summarizing, certain aspects, advantages, and novel features have been described herein. It is to be understood that not all such advantages may be achieved in accordance with any one particular embodiment. Thus, the disclosed subject matter may be embodied or carried out in a manner that achieves or optimizes one advantage or group of advantages without achieving all advantages as may be taught or suggested herein.

In accordance with some implementations of the disclosed subject matter, computer implemented methods and systems are provided to determine the possibility of first party fraud based on data related to the characteristics of the first party as well as information about the network of other entities associated with the first party.

A computer-implemented fraud detection method and system for periodically identifying network associations in a consumer population at a national credit reporting agency and computing associated network level variables related to credit use and potential first party fraud for the consumer population. In response to receiving a request for a target account from among the consumer population the computer-implemented system retrieves credit report for the target account and computes tradeline or account level variables related to credit use and potential fraudulent behavior. A fraud score is calculated based on a combined evaluation of the network level variables and the tradeline or account level variables.

In some implementations the system or method may be configured for accessing credit-related data for a plurality of entities, wherein histories of credit-related activities for the plurality of entities is stored in at least one data storage medium accessible by one or more computing devices, the one or more computing devices comprising processing resources for analyzing the credit-related data and determining connection patterns among the plurality of entities, in response to analyzing the credit-related data to determine relationships between the one or more entities, the determined connection patterns being utilized to generate a data structure representing a relationship graph.

The nodes in the relationship graph may represent the plurality of entities. Edges connecting the nodes in the relationship graph may represent the relations between the plurality of entities. A model may be built based on the relationship graph and an analysis of the credit-related data based on which a fraud score for at least one entity from among the plurality of entities may be calculated. In one embodiment, an electronic signal may be generated and transmitted to a computer-implemented user interface to create a report that visually represents at least the fraud score for the at least one entity or a visual presentation of the one or more of the plurality of entities and the relations between the one or more of the plurality of entities.

The details of one or more variations of the subject matter described herein are set forth in the accompanying drawings and the description below. Other features and advantages of the subject matter described herein will be apparent from the description and drawings, and from the claims. The disclosed subject matter is not, however, limited to any particular embodiment disclosed.

### BRIEF DESCRIPTION OF THE DRAWINGS

The accompanying drawings, which are incorporated in and constitute a part of this specification, show certain aspects of the subject matter disclosed herein and, together with the description, help explain some of the principles associated with the disclosed implementations as provided below.

FIG. 1 illustrates an example operating environment in accordance with one or more embodiments, wherein a user may utilize a computing system to process entity information to generate a fraud risk score.

FIG. 2 is an example block diagram of entity and network characteristics that may be used to determine first party fraud risk score, in accordance with one or more embodiments.

FIGS. 3 and 4 are example flow diagrams of methods or processes for generating a first party fraud risk score, in accordance with certain embodiments.

FIG. 5 is an example block diagram of a collection of predictive data characteristics that may be used to calculate a first party fraud risk score, in accordance with one or more embodiments.

FIG. 6 is a block diagram of a computing system that may be utilized to perform one or more computer processes disclosed herein as consistent with one or more embodiments.

Where practical, the same or similar reference numbers denote the same or similar or equivalent structures, features, aspects, or elements, in accordance with one or more embodiments.

### DETAILED DESCRIPTION OF EXAMPLE IMPLEMENTATIONS

In the following, numerous specific details are set forth to provide a thorough description of various embodiments. Certain embodiments may be practiced without these specific details or with some variations in detail. In some instances, certain features are described in less detail so as not to obscure other aspects. The level of detail associated with each of the elements or features should not be construed to qualify the novelty or importance of one feature over the others.

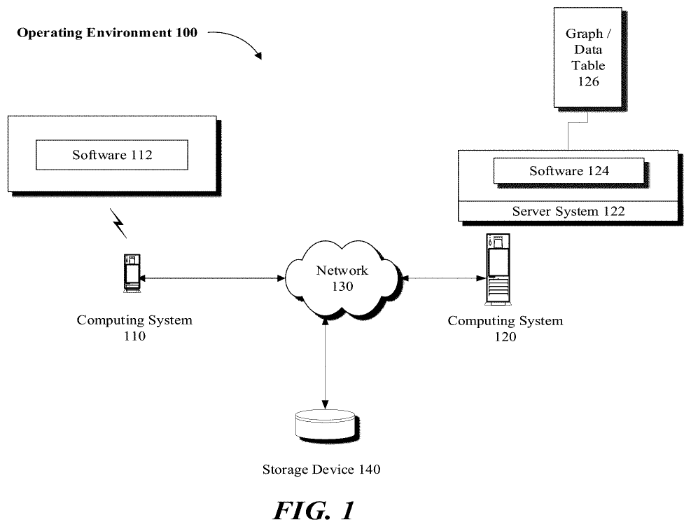

Referring to FIG. 1, an example operating environment 100 is illustrated in which a computing system 110 may be used by an entity or a user to interact with software 112 (e.g., a fraud detection software) being executed on computing system 110. The computing system 110 may be a general-purpose computer, a handheld mobile device (e.g., a smart phone), a tablet, or other communication capable computing device. Software 112 may be a web browser, a dedicated app or other type of software application running either fully or partially on computing system 110.

Computing system 110 may communicate over a network 130 to access data stored on storage device 140 or to access services provided by a computing system 120. Depending on implementation, storage device 140 may be local to, remote to, or embedded in one or more of computing systems 110 or 120. A server system 122 may be configured on computing system 120 to service one or more requests submitted by computing system 110 or software 112 (e.g., client systems) via network 130. Network 130 may be implemented over a local or wide area network (e.g., the Internet).

Computing system 120 and server system 122 may be implemented over a centralized or distributed (e.g., cloud-based) computing environment as dedicated resources or may be configured as virtual machines that define shared processing or storage resources. Execution, implementation or instantiation of software 124, or the related features and components (e.g., software objects), over server system 122 may also define a special purpose machine that provides remotely situated client systems, such as computing system 110 or software 112, with access to a variety of data and services as provided below.

In accordance with one or more implementations, the provided services by the special purpose machine or software 124 may include providing a user, using computing system 110 or software 112, with access to a fraud detection system or a machine learning model configured to generate a score indicating possibility of fraudulent activity for one or more persons or entities based on known or recognizable relationships and characteristics. It is noteworthy that the computing environment 100 and the components illustrated in FIG. 1A are provided by way of example and other components or computing environment with additional or different features and compositions may be implemented to support the functionality discussed in further detail herein.

In accordance with one or more implementation, analytics about an entity's network of relationships or associates may be used to generate a score that provides an indication for first party fraud behavior. An entity as referred to herein may be a consumer, an applicant, an individual or other party with a definable identity, credit or transaction history. In one embodiment, bureau data or other available information about one or more entities may be used to generate a relationship graph or data structure, such as a data table 126, a data tree or other type of data structure with multiple nodes. One or more nodes may be used to represent entities with, for example, a credit history. The relationship graph (e.g., data table 126) may be stored either locally in computing system 120 memory or in a remote storage device 140.

The relationship graph may also identify the relationships between the entities according to information retrieved from a resource (e.g., a database) that stores relationship or networking data about related entities. The relationship information may be based on cross-financial intelligence or entity network data, for example, and can help efficiently identify relationships between certain individuals and entities where such relationships are not otherwise ascertainable from analyzing credit history. As provided in further detail herein, the relationship graph may be implemented to include data that can help efficiently connect or identify connections among various entities and individuals and the connections may be based on at least one of individual consumer level characteristics, network level characteristics, or predictive data characteristics.

In one aspect, nodes in the relationship graph may be connected to other nodes in the graph, where an edge connecting two nodes indicates an association between the entities represented by a node, for example. The information available for an entity and the relationship between the entities may be incorporated into the respective nodes and the knowledge of the information within the context of the relationship between the nodes may be used to determine an entity's fraud risk. In accordance with one variation, the fraud risk for an entity may be evaluated based on events (i.e., credit-related activity or financial transactions, etc.) associated with a target entity and events associated with other entities who are related to the target entity.

As provided in further detail herein, the fraud risk evaluation or result generated may be in form of a score that may be used to determine whether the entity is a credit risk and also whether the entity's application is based on fabricated information or related to other entities involved in credit abuse or fraud. In certain embodiments, a real-time or near-real-time risk analysis score may be calculated based on accessing identifying data and analyzing various factors (e.g., name, address, SSN, DOB, driver license, phone number, address, etc.) included in credit bureau data for an entity.

To further enhance the risk analysis, additional information available about the network or ecosystem in which the entity co-exists with others may be also accessed and analyzed. The additional information may include clues or suggestions about whether an entity may be involved in (or related to other entities who may or may be known to be involved in) questionable, fraudulent or criminal activities. The additional information may be obtained from sources that track lending or credit analysis nationwide (or worldwide) and can extend to collecting information about entities who have joint accounts or other relationships and associations with a target entity.

In one implementation, acquisition, management and recovery factors may be considered to determine chances for risk or a history of fraud associated with an entity or a history of fraud or risk associated with other individuals or activities associated with the entity. The risk factors and the related history may be determined based on an Nth degree of relationship, in accordance with the information included or obtained from the relationship graph, N being a positive number.

In some embodiments, to determine the risk factors, an extensive library of predictive characteristics built on consumer credit histories that span across financial institutions may be accessed and utilized according to various degrees, levels or hierarchies in the relationship graph. For example, when analyzing or determining a target entity's financial history and ultimate risk score, available information about multiple connected entities that have a certain degree of relationship with the target entity may be considered.

As provided in further detail below, a computer-implemented data structure (e.g., a relationship graph) that can efficiently identify a web of relationships between various entities and individuals may be constructed based on a variety of publicly or privately available information. This information may be utilized to help identify connections and associations among entities and individuals that may be engaged in fraudulent activities, either individually or in concert, based on the recognition of a pattern of fraudulent or suspect activities.

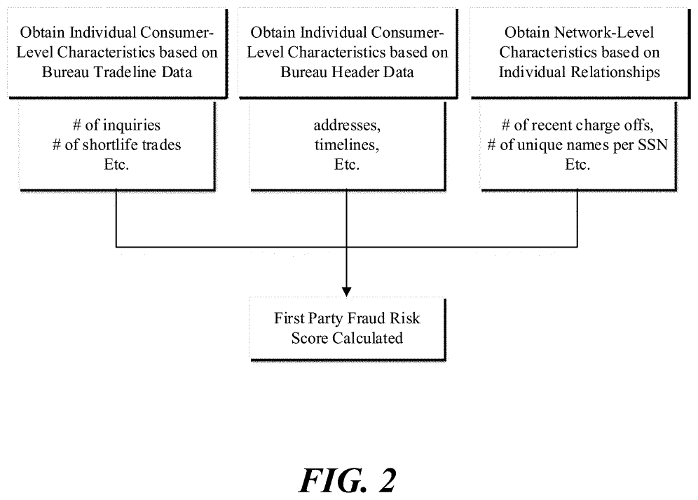

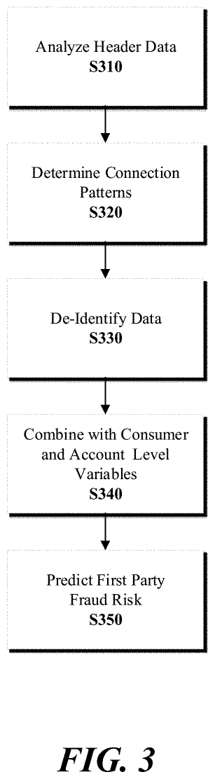

Referring to FIGS. 2 and 3, in certain embodiments, an individual's or an entity's characteristics may be obtained based on one or more of the following information: a credit bureau tradeline data (e.g., loan or credit balances, number of credit or trade inquiries during a certain time period, number of short life trades, loan or credit balances over a time period, etc.), the credit bureau header data (e.g., a consumers names, birth dates, social security number (SSN), addresses, timeline or history of the consumers change in location or trades, or legal events such as judgements and associated amounts or satisfaction status, etc.). Other information that may be considered may be based on network level characteristics and relationships (e.g., number of recent charge offs, number of unique names for shared SSNs, etc.), or a combination of the above data available for the target entity or individual and its related associations.

In certain embodiments, some or all of the above information and related data may be analyzed, for example, using proprietary fuzzy matching (S310). Based on the analysis, known connection patterns or hidden connection patterns in the data may be determined by, for example, identifying common characteristic to build the relationship graph (S320). Depending on the degree of relationships considered, N or more nodes connected to a node associated with the target entity or individual in the relationship graph may be traversed. The data analyzed or collected from traversing the nodes may be de-identified (S330) and combined with consumer and account level variables (S340) to create an accurate prediction of first party fraud risk (S350). In accordance with one aspect, network associations in, for example, relevant consumer populations at a national credit reporting agency may be identified on a periodic (e.g., daily or monthly) basis and the relationship graph may be updated accordingly.

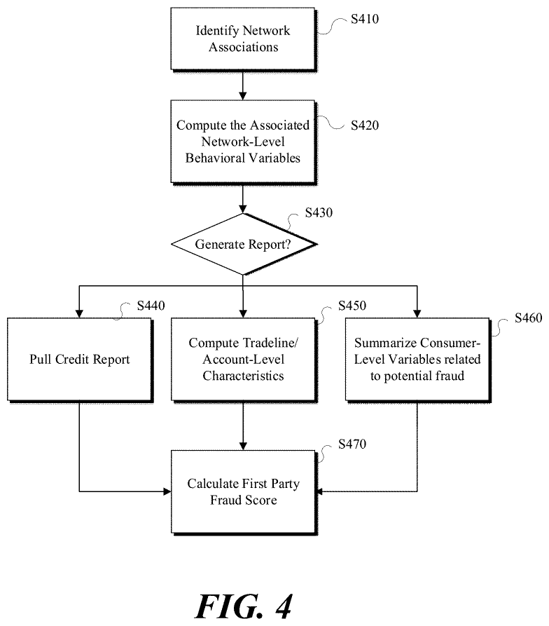

Referring to FIG. 4, in accordance with one example embodiment, network connections and relationships of interest may be identified, for example, using the relationship graph (S410). Network connections of interest may include connections between individuals or entities from networks or databases that include a body of information about individual and entity relationships based on shared addresses, shared accounts or shared rights or interests. To provide a meaningful understanding of the relationships, associated network-level behavioral variables may be computed, for example, as related to credit use and potential first party fraud (S420). In some embodiments, a report may be generated that includes a summary or a detailed level analysis of the identified connections and relationships (S430). Depending on implementation, the identification of the connections and relationships and the related computations may be performed on a regular basis or in real-time or near-real-time, as needed.

In certain embodiments, the updating of the relationship graph data and the noted identifications of relationships and computations are performed in advance of receiving a request to generate a first party fraud score for a target individual or entity. Referring to FIGS. 1 and 4, a user may utilize computing system 110 to submit a request over network 130 for a first party fraud score. In response, a consumer credit report for the target may be pulled by computing system 120 (S440). Tradeline or account level characteristics may be computed based on the updated data available for the target entity (S450). Consumer-level characteristics or variables related to credit use and potential first party fraud behaviors may be then identified or detected and summarized based on an analysis of the available information for the target first party entity and the determined associations in the relationship graph, for example (S460). Advantageously, using the results of the above analysis, a first party fraud score may be determined very efficiently without having to access additional resources at the time the analysis results are obtained (S470).

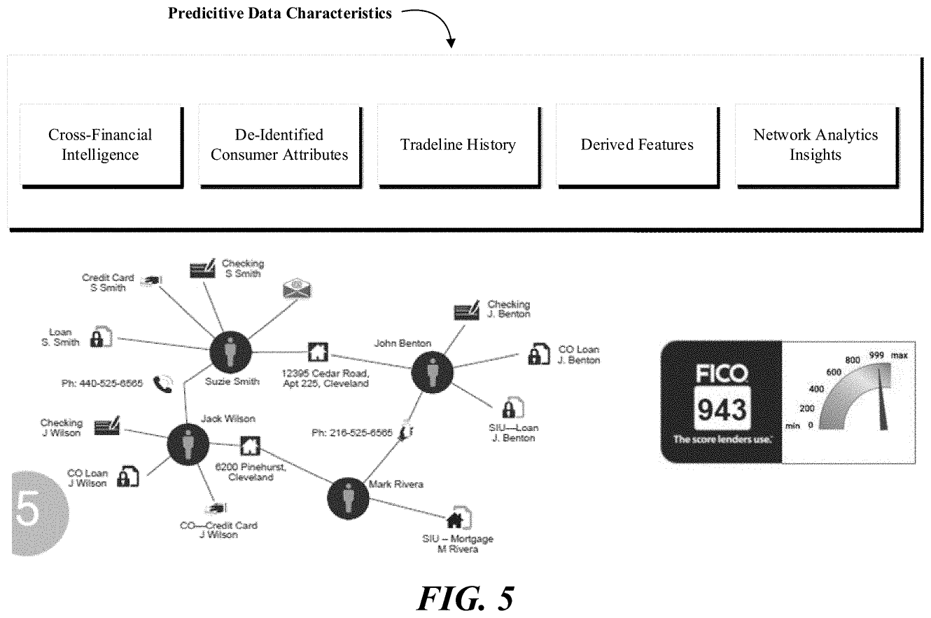

Accordingly, in certain embodiments, the first party fraud score may be determined based on a combination or consideration of network-level characteristics and tradeline or individual-level predictive characteristics. As shown in FIG. 5, the predictive characteristics may include one or more of cross-financial intelligence data, de-identified consumer attributes, tradeline history, features derived from the above data, or network analytics insights. Network insights may include information about links to known frauds or fraudulent individuals or entities, homogeneity of common attribute linking, high velocity accounts and number of charge offs associated with a target individual. Optimally, the result may be generated as a single easily understandable score that reflects the target entity or individual's possible ties to, or likelihood for engaging in, fraudulent activity.

In certain embodiments, a graphical result such as that shown in FIG. 5 may be also included for ease of understanding of the relationships between a target individual or entity and other related individuals or entities based on information in the relationship graph. The graphical results may for example provide information about a target individual (e.g., Ms. Smith) and her relations or associations with other individuals (e.g., Mr. Wilson and Mr. Benton). The result may also illustrate as shown in FIG. 5 that the target individual has a common address with Mr. Benton and that she is in communication with Mr. Wilson or has a joint credit card with Mr. Wilson. If one or more parties associated with the target individual are suspected of fraudulent activity, the graphical result may highlight that information or the score calculated for Ms. Smith may be updated to reflect the same.

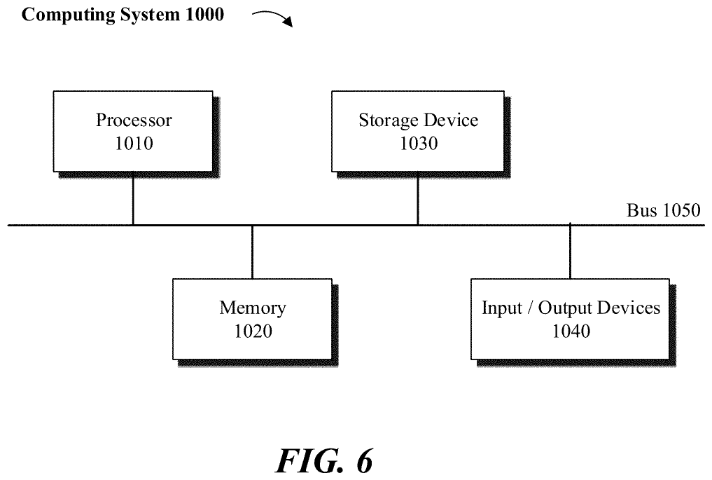

Referring to FIG. 6, a block diagram illustrating a computing system 1000 consistent with one or more embodiments is provided. The computing system 1000 may be used to implement or support one or more platforms, infrastructures or computing devices or computing components that may be utilized, in example embodiments, to instantiate, implement, execute or embody the methodologies disclosed herein in a computing environment using, for example, one or more processors or controllers, as provided below.

As shown in FIG. 6, the computing system 1000 can include a processor 1010, a memory 1020, a storage device 1030, and input/output devices 1040. The processor 1010, the memory 1020, the storage device 1030, and the input/output devices 1040 can be interconnected via a system bus 1050. The processor 1010 is capable of processing instructions for execution within the computing system 1000. Such executed instructions can implement one or more components of, for example, a cloud platform. In some implementations of the current subject matter, the processor 1010 can be a single-threaded processor. Alternately, the processor 1010 can be a multi-threaded processor. The processor 1010 is capable of processing instructions stored in the memory 1020 and/or on the storage device 1030 to display graphical information for a user interface provided via the input/output device 1040.

The memory 1020 is a computer readable medium such as volatile or non-volatile that stores information within the computing system 1000. The memory 1020 can store data structures representing configuration object databases, for example. The storage device 1030 is capable of providing persistent storage for the computing system 1000. The storage device 1030 can be a floppy disk device, a hard disk device, an optical disk device, or a tape device, or other suitable persistent storage means. The input/output device 1040 provides input/output operations for the computing system 1000. In some implementations of the current subject matter, the input/output device 1040 includes a keyboard and/or pointing device. In various implementations, the input/output device 1040 includes a display unit for displaying graphical user interfaces.

According to some implementations of the current subject matter, the input/output device 1040 can provide input/output operations for a network device. For example, the input/output device 1040 can include Ethernet ports or other networking ports to communicate with one or more wired and/or wireless networks (e.g., a local area network (LAN), a wide area network (WAN), the Internet).

In some implementations of the current subject matter, the computing system 1000 can be used to execute various interactive computer software applications that can be used for organization, analysis and/or storage of data in various (e.g., tabular) format (e.g., Microsoft Excel®, and/or any other type of software). Alternatively, the computing system 1000 can be used to execute any type of software applications. These applications can be used to perform various functionalities, e.g., planning functionalities (e.g., generating, managing, editing of spreadsheet documents, word processing documents, and/or any other objects, etc.), computing functionalities, communications functionalities, etc. The applications can include various add-in functionalities or can be standalone computing products and/or functionalities. Upon activation within the applications, the functionalities can be used to generate the user interface provided via the input/output device 1040. The user interface can be generated and presented to a user by the computing system 1000 (e.g., on a computer screen monitor, etc.).

One or more aspects or features of the subject matter disclosed or claimed herein may be realized in digital electronic circuitry, integrated circuitry, specially designed application specific integrated circuits (ASICs), field programmable gate arrays (FPGAs) computer hardware, firmware, software, and/or combinations thereof. These various aspects or features may include implementation in one or more computer programs that may be executable and/or interpretable on a programmable system including at least one programmable processor, which may be special or general purpose, coupled to receive data and instructions from, and to transmit data and instructions to, a storage system, at least one input device, and at least one output device. The programmable system or computing system may include clients and servers. A client and server may be remote from each other and may interact through a communication network. The relationship of client and server arises by virtue of computer programs running on the respective computers and having a client-server relationship to each other.

These computer programs, which may also be referred to as programs, software, software applications, applications, components, or code, may include machine instructions for a programmable controller, processor, microprocessor or other computing or computerized architecture, and may be implemented in a high-level procedural language, an object-oriented programming language, a functional programming language, a logical programming language, and/or in assembly/machine language. As used herein, the term “machine-readable medium” refers to any computer program product, apparatus and/or device, such as for example magnetic discs, optical disks, memory, and Programmable Logic Devices (PLDs), used to provide machine instructions and/or data to a programmable processor, including a machine-readable medium that receives machine instructions as a machine-readable signal. The term “machine-readable signal” refers to any signal used to provide machine instructions and/or data to a programmable processor. The machine-readable medium may store such machine instructions non-transitorily, such as for example as would a non-transient solid-state memory or a magnetic hard drive or any equivalent storage medium. The machine-readable medium may alternatively or additionally store such machine instructions in a transient manner, such as for example as would a processor cache or other random access memory associated with one or more physical processor cores.

To provide for interaction with a user, one or more aspects or features of the subject matter described herein can be implemented on a computer having a display device, such as for example a cathode ray tube (CRT) or a liquid crystal display (LCD) or a light emitting diode (LED) monitor for displaying information to the user and a keyboard and a pointing device, such as for example a mouse or a trackball, by which the user can provide input to the computer. Other kinds of devices can be used to provide for interaction with a user as well. For example, feedback provided to the user can be any form of sensory feedback, such as for example visual feedback, auditory feedback, or tactile feedback; and input from the user can be received in any form, including acoustic, speech, or tactile input. Other possible input devices include touch screens or other touch-sensitive devices such as single or multi-point resistive or capacitive track pads, voice recognition hardware and software, optical scanners, optical pointers, digital image capture devices and associated interpretation software, and the like.

### Terminology

When a feature or element is herein referred to as being “on” another feature or element, it may be directly on the other feature or element or intervening features and/or elements may also be present. In contrast, when a feature or element is referred to as being “directly on” another feature or element, there may be no intervening features or elements present. It will also be understood that, when a feature or element is referred to as being “connected”, “attached” or “coupled” to another feature or element, it may be directly connected, attached or coupled to the other feature or element or intervening features or elements may be present. In contrast, when a feature or element is referred to as being “directly connected”, “directly attached” or “directly coupled” to another feature or element, there may be no intervening features or elements present.

Although described or shown with respect to one embodiment, the features and elements so described or shown may apply to other embodiments. It will also be appreciated by those of skill in the art that references to a structure or feature that is disposed “adjacent” another feature may have portions that overlap or underlie the adjacent feature.

Terminology used herein is for the purpose of describing particular embodiments and implementations only and is not intended to be limiting. For example, as used herein, the singular forms “a”, “an” and “the” may be intended to include the plural forms as well, unless the context clearly indicates otherwise. It will be further understood that the terms “comprises” and/or “comprising,” when used in this specification, specify the presence of stated features, steps, operations, processes, functions, elements, and/or components, but do not preclude the presence or addition of one or more other features, steps, operations, processes, functions, elements, components, and/or groups thereof. As used herein, the term “and/or” includes any and all combinations of one or more of the associated listed items and may be abbreviated as “/”.

In the descriptions above and in the claims, phrases such as “at least one of” or “one or more of” may occur followed by a conjunctive list of elements or features. The term “and/or” may also occur in a list of two or more elements or features. Unless otherwise implicitly or explicitly contradicted by the context in which it used, such a phrase is intended to mean any of the listed elements or features individually or any of the recited elements or features in combination with any of the other recited elements or features. For example, the phrases “at least one of A and B;” “one or more of A and B;” and “A and/or B” are each intended to mean “A alone, B alone, or A and B together.” A similar interpretation is also intended for lists including three or more items. For example, the phrases “at least one of A, B, and C;” “one or more of A, B, and C;” and “A, B, and/or C” are each intended to mean “A alone, B alone, C alone, A and B together, A and C together, B and C together, or A and B and C together.” Use of the term “based on,” above and in the claims is intended to mean, “based at least in part on,” such that an unrecited feature or element is also permissible.

Spatially relative terms, such as “forward”, “rearward”, “under”, “below”, “lower”, “over”, “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if a device in the figures is inverted, elements described as “under” or “beneath” other elements or features would then be oriented “over” the other elements or features due to the inverted state. Thus, the term “under” may encompass both an orientation of over and under, depending on the point of reference or orientation. The device may be otherwise oriented (rotated 90 degrees or at other orientations) and the spatially relative descriptors used herein interpreted accordingly. Similarly, the terms “upwardly”, “downwardly”, “vertical”, “horizontal” and the like may be used herein for the purpose of explanation only unless specifically indicated otherwise.

Although the terms “first” and “second” may be used herein to describe various features/elements (including steps or processes), these features/elements should not be limited by these terms as an indication of the order of the features/elements or whether one is primary or more important than the other, unless the context indicates otherwise. These terms may be used to distinguish one feature/element from another feature/element. Thus, a first feature/element discussed could be termed a second feature/element, and similarly, a second feature/element discussed below could be termed a first feature/element without departing from the teachings provided herein.

As used herein in the specification and claims, including as used in the examples and unless otherwise expressly specified, all numbers may be read as if prefaced by the word “about” or “approximately,” even if the term does not expressly appear. The phrase “about” or “approximately” may be used when describing magnitude and/or position to indicate that the value and/or position described is within a reasonable expected range of values and/or positions. For example, a numeric value may have a value that is +/−0.1% of the stated value (or range of values), +/−1% of the stated value (or range of values), +/−2% of the stated value (or range of values), +/−5% of the stated value (or range of values), +/−10% of the stated value (or range of values), etc. Any numerical values given herein should also be understood to include about or approximately that value, unless the context indicates otherwise.

For example, if the value “10” is disclosed, then “about 10” is also disclosed. Any numerical range recited herein is intended to include all sub-ranges subsumed therein. It is also understood that when a value is disclosed that “less than or equal to” the value, “greater than or equal to the value” and possible ranges between values are also disclosed, as appropriately understood by the skilled artisan. For example, if the value “X” is disclosed the “less than or equal to X” as well as “greater than or equal to X” (e.g., where X is a numerical value) is also disclosed. It is also understood that the throughout the application, data is provided in a number of different formats, and that this data, may represent endpoints or starting points, and ranges for any combination of the data points. For example, if a particular data point “10” and a particular data point “15” may be disclosed, it is understood that greater than, greater than or equal to, less than, less than or equal to, and equal to 10 and 15 may be considered disclosed as well as between 10 and 15. It is also understood that each unit between two particular units may be also disclosed. For example, if 10 and 15 may be disclosed, then 11, 12, 13, and 14 may be also disclosed.

Although various illustrative embodiments have been disclosed, any of a number of changes may be made to various embodiments without departing from the teachings herein. For example, the order in which various described method steps are performed may be changed or reconfigured in different or alternative embodiments, and in other embodiments one or more method steps may be skipped altogether. Optional or desirable features of various device and system embodiments may be included in some embodiments and not in others. Therefore, the foregoing description is provided primarily for the purpose of example and should not be interpreted to limit the scope of the claims and specific embodiments or particular details or features disclosed.

The examples and illustrations included herein show, by way of illustration and not of limitation, specific embodiments in which the disclosed subject matter may be practiced. As mentioned, other embodiments may be utilized and derived therefrom, such that structural and logical substitutions and changes may be made without departing from the scope of this disclosure. Such embodiments of the disclosed subject matter may be referred to herein individually or collectively by the term “invention” merely for convenience and without intending to voluntarily limit the scope of this application to any single invention or inventive concept, if more than one is, in fact, disclosed. Thus, although specific embodiments have been illustrated and described herein, any arrangement calculated to achieve an intended, practical or disclosed purpose, whether explicitly stated or implied, may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

The disclosed subject matter has been provided here with reference to one or more features or embodiments. Those skilled in the art will recognize and appreciate that, despite of the detailed nature of the example embodiments provided here, changes and modifications may be applied to said embodiments without limiting or departing from the generally intended scope. These and various other adaptations and combinations of the embodiments provided here are within the scope of the disclosed subject matter as defined by the disclosed elements and features and their full set of equivalents.

What is claimed is:

1. A computer-implemented fraud detection method comprising:
accessing credit-related data for a plurality of entities, wherein histories of credit-related activities for the plurality of entities is stored in at least one data storage medium accessible by one or more computing devices, the one or more computing devices comprising processing resources for analyzing the credit-related data;
determining connection patterns among the plurality of entities, in response to analyzing the credit-related data to determine relationships between the one or more entities, the determined connection patterns being utilized to generate a data structure representing a relationship graph, the nodes in the relationship graph representing the plurality of entities and edges connecting the nodes in the relationship graph representing the relations between the plurality of entities; and
building a model based on the relationship graph and an analysis of the credit-related data based on which a fraud score for at least one entity from among the plurality of entities may be calculated.

2. The method of claim 1, wherein in response to receiving a request for determining the fraud score for a target entity from the plurality of entities, credit report data for the target entity in combination with tradeline characteristics for the target entity is utilized to calculate the fraud score for the target entity.

3. The method of claim 1, wherein tradeline characteristics comprise at least one of number of credit or trade inquiries associated with the target entity during a first time period, number of short life trades associated with the target entity, and loan or credit balances associated with the target entity over a second time period.

4. The method of claim 3, wherein the first time period is the same as the second time period.

5. The method of claim 3, wherein the first time period is different from or partially overlaps with the second time period.

6. The method of claim 1, wherein the relationship graph is implemented in form of a computer-implemented data structure that is periodically updated to include changes or new relationships between the plurality of entities.

7. The method of claim 6, wherein the relationship graph is a data tale or a data tree.

8. The method of claim 1, wherein the fraud score is calculated based on individual consumer-level characteristics based on a credit bureau tradeline data.

9. The method of claim 1, wherein the fraud score is calculated based on individual consumer-level characteristics based on a credit bureau header data.

10. The method of claim 1, wherein the fraud score is calculated based on network-level characteristics and entity relationships.

11. A system comprising:
at least one programmable processor; and
a non-transitory machine-readable medium storing instructions that, when executed by the at least one programmable processor, cause the at least one programmable processor to perform operations comprising:
accessing credit-related data for a plurality of entities, wherein histories of credit-related activities for the plurality of entities is stored in at least one data storage medium accessible by one or more computing devices, the one or more computing devices comprising processing resources for analyzing the credit-related data;
determining connection patterns among the plurality of entities, in response to analyzing the credit-related data to determine relationships between the one or more entities, the determined connection patterns being utilized to generate a data structure representing a relationship graph, the nodes in the relationship graph representing the plurality of entities and edges connecting the nodes in the relationship graph representing the relations between the plurality of entities; and
building a model based on the relationship graph and an analysis of the credit-related data based on which a fraud score for at least one entity from among the plurality of entities may be calculated.

12. The system of claim 11, wherein in response to receiving a request for determining the fraud score for a target entity from the plurality of entities, credit report data for the target entity in combination with tradeline characteristics for the target entity is utilized to calculate the fraud score for the target entity.

13. The system of claim 11, wherein tradeline characteristics comprise at least one of number of credit or trade inquiries associated with the target entity during a first time period, number of short life trades associated with the target entity, and loan or credit balances associated with the target entity over a second time period.

14. The system of claim 13, wherein the first time period is the same as the second time period.

15. The system of claim 13, wherein the first time period is different from or partially overlaps with the second time period.

16. The system of claim 11, wherein the relationship graph is implemented in form of a computer-implemented data structure that is periodically updated to include changes or new relationships between the plurality of entities.

17. The system of claim 11, wherein the fraud score is calculated based on network-level characteristics and entity relationships.

18. A computer program product comprising a non-transitory machine-readable medium storing instructions that, when executed by at least one programmable processor, cause the at least one programmable processor to perform operations comprising:
periodically identifying network associations in a consumer population at a national credit reporting agency;
periodically compute associated network level variables related to credit use and potential first party fraud for the consumer population; and
in response to receiving a request for a target account from among the consumer population:
retrieve credit report for the target account;
compute tradeline or account level variables related to credit use and potential fraudulent behavior; and
calculate a fraud score based on a combined evaluation of the network level variables and the tradeline or account level variables.

19. The computer program product of claim 18, wherein in response to receiving a request for determining the fraud score, credit report data for the target account in combination with tradeline characteristics for the target account is utilized to calculate the fraud score.

20. The computer program product of claim 19, wherein tradeline characteristics comprise at least one of number of credit or trade inquiries associated with the target account during a first time period, number of short life trades associated with the target account, and loan or credit balances associated with the target account over a second time period.
